(19) United States
(12) Patent Application Publication
(10) Pub. No.: US 2025/0237487 A1
(43) Pub. Date: Jul. 24, 2025

(54) PERSONAL SAFETY DEVICE

(71) Applicant: Safely Inc., Houston, TX (US)

(72) Inventors: Ashley Raymond, Houston, TX (US); Danna Tao, Denver, CO (US); Meagan Doyle, Kerrville, TX (US); Margaret McCallum, Santa Monica, CA (US); John E. Voltin, Leander, TX (US)

(21) Appl. No.: 19/035,610

(22) Filed: Jan. 23, 2025

Related U.S. Application Data
(60) Provisional application No. 63/666,580, filed on Jul. 1, 2024.
(60) Provisional application No. 63/639,120, filed on Apr. 26, 2024.
(60) Provisional application No. 63/624,169, filed on Jan. 23, 2024.

(51) Int. Cl. F41H 9/10; A62B 3/00; F41B 15/04; F41B 15/08

(52) U.S. Cl. CPC F41H 9/10; A62B 3/005; F41B 15/04; F41B 15/08

(57) ABSTRACT

There is disclosed herein, by way of example, a personal safety device having a main body having disposed therein a non-lethal defensive weapon (such as pepper spray, taser, or baton); a hand enclosure; a light; and a bottom attachment; wherein the main body is constructed with a size and shape to comfortably fit an average human female hand.

### CROSS-REFERENCE TO RELATED APPLICATIONS

This application claims the benefit of and priority from U.S. Provisional Application Ser. No. 63/666,580 titled “PERSONAL SAFETY DEVICE” filed on Jul. 1, 2024, U.S. Provisional Application Ser. No. 63/624,169 titled “PERSONAL SAFETY DEVICE” filed on Apr. 26, 2024, U.S. Provisional Application Ser. No. 63/639,120 titled “PERSONAL SAFETY DEVICE” filed on Jan. 23, 2024, U.S. Design application Ser. No. 29/925,041 titled “PERSONAL SAFETY DEVICE” filed on Jan. 22, 2024, and are hereby incorporated by reference in their entirety.

### FIELD OF THE SPECIFICATION

This disclosure relates in general to personal safety, and more particularly though not exclusively to a personal safety device.

### BACKGROUND

It is beneficial for individuals to be able to defend themselves from attackers. Women and girls in particular may benefit from apparatus that multiply their intrinsic self-defense capabilities.

### BRIEF DESCRIPTION OF THE DRAWINGS

The present disclosure is best understood from the following detailed description when read with the accompanying figures. It is emphasized that, in accordance with the standard practice in the industry, various features are not necessarily drawn to scale, and are used for illustration purposes only. Where a scale is shown, explicitly or implicitly, it provides only one illustrative example. In other embodiments, the dimensions of the various features may be arbitrarily increased or reduced for clarity of discussion.

FIG. 1 is a front perspective view of a personal safety device.

FIG. 2 is a front elevation view of a personal safety device.

FIG. 3 is a rear elevation view of a personal safety device.

FIG. 4 is a right side view of a personal safety device.

FIG. 5 is a left side view of a personal safety device.

FIG. 6 is a top view of a personal safety device.

FIG. 7 is a bottom view of a personal safety.

FIG. 8 is a rear perspective view of a personal safety device.

FIG. 9 is an environmental view of an embodiment of a personal safety device.

FIG. 10 is a perspective view of an embodiment of a personal safety device.

FIG. 11 is a perspective view of an embodiment of a personal safety device.

FIG. 12 is a perspective view of an embodiment of a personal safety device.

FIG. 13 is a perspective view of an embodiment of a personal safety device.

FIG. 14 is a perspective view of an embodiment of a personal safety device.

FIG. 15 is a perspective view of an embodiment of a personal safety device.

FIG. 16 is a block diagram of selected elements of an electronic control module.

### SUMMARY

There is disclosed, in one example, a personal safety device, comprising: a main body having disposed therein a non-lethal defensive weapon; a hand enclosure; a light; and a bottom attachment; wherein the main body is constructed with a size and shape to comfortably fit an average human female hand.

There is further disclosed an example, wherein the main body has a length of between 5 and 7 inches.

There is further disclosed an example, wherein the main body has a length of approximately 6 inches.

There is further disclosed an example, wherein the main body has a diameter between 0.5 and 2.5 inches.

There is further disclosed an example, wherein the main body has a diameter between 1.3 and 1.5 inches.

There is further disclosed an example, wherein the main body has an oblong ergonomic contour.

There is further disclosed an example, wherein the non-lethal defensive weapon comprises an aerosol lachrymatory agent.

There is further disclosed an example, wherein the aerosol lachrymatory agent is contained within a disposable or rechargeable cartridge.

There is further disclosed an example, wherein the hand enclosure is a removeable attachment.

There is further disclosed an example, wherein the cartridge interlocks with the hand enclosure, whereby the hand enclosure is not removeable with the cartridge inserted.

There is further disclosed an example, wherein the non-lethal defensive weapon comprises a conducted energy device (CED).

There is further disclosed an example, further comprising a rechargeable power supply.

There is further disclosed an example, further comprising a disposable battery acceptor.

There is further disclosed an example, further comprising a dual-power supply, including a rechargeable battery and a disposable battery acceptor.

There is further disclosed an example, wherein the CED comprises ejectable electrical leads affixed to wire conductors.

There is further disclosed an example, wherein the CED comprises fixed electrical terminals.

There is further disclosed an example, wherein the non-lethal defensive weapon comprises a telescoping friction baton.

There is further disclosed an example, wherein the telescoping friction baton comprises three telescoping segments.

There is further disclosed an example, wherein the three telescoping segments comprise an outer segment integrated with the main body.

There is further disclosed an example, wherein the three telescoping segments comprise an intermediate segment of a lightweight material.

There is further disclosed an example, wherein the three telescoping segments are constructed of steel, aluminum, carbon fiber, titanium, or a combination thereof.

There is further disclosed an example, wherein the three telescoping segments comprise an outer segment, an intermediate segment, and a core segment, and wherein the core segment is of a hardened material.

There is further disclosed an example, wherein the telescoping friction baton has terminals for a conducted energy device (CED) disposed on a butt end of the telescoping friction baton.

There is further disclosed an example, wherein the telescoping friction baton has an extended length of approximately 16 inches.

There is further disclosed an example, wherein the hand enclosure comprises a strap.

There is further disclosed an example, wherein the hand enclosure comprises a knuckle attachment.

There is further disclosed an example, wherein the knuckle attachment is constructed of hardened plastic.

There is further disclosed an example, wherein the knuckle attachment is constructed of aluminum or steel.

There is further disclosed an example, further comprising a wrist loop.

There is further disclosed an example, further comprising an alarm, wherein the wrist loop is detachable, and wherein detaching the wrist loop activates the alarm.

There is further disclosed an example, wherein the hand enclosure comprises two or more interchangeable attachments.

There is further disclosed an example, wherein the interchangeable attachments include a spiked knuckle attachment and a strap attachment.

There is further disclosed an example, wherein the bottom attachment comprises a key ring.

There is further disclosed an example, wherein the bottom attachment comprises a glass breaker.

There is further disclosed an example, wherein the bottom attachment is removeable and interchangeable with one or more other bottom attachments.

There is further disclosed an example, wherein the main body has a color scheme or pattern selected to appeal to female users.

There is further disclosed an example of a personal safety device, comprising: a main body having disposed therein an aerosol lachrymatory agent cartridge, with a spray nozzle oriented towards a first end of a short axis of the personal safety device; a hand enclosure located on the first end; a receiver for an attachment, the receiver located on a bottom end of a long axis of the personal safety device; a light oriented towards the first end; and an actuator button on a second end of the short axis of the personal safety device; wherein the main body is constructed with a size and shape to comfortably fit an average human female hand.

There is further disclosed an example, wherein the main body has a length of between 5 and 7 inches.

There is further disclosed an example, wherein the main body has a length of approximately 6 inches.

There is further disclosed an example, wherein the main body has a diameter between 0.5 and 2.5 inches.

There is further disclosed an example, wherein the main body has a diameter between 1.3 and 1.5 inches.

There is further disclosed an example, wherein the main body has an oblong ergonomic contour.

There is further disclosed an example, wherein cartridge is removeable, and is rechargeable or disposable.

There is further disclosed an example, wherein the hand enclosure is a removeable attachment.

There is further disclosed an example, wherein the cartridge interlocks with the hand enclosure, whereby the hand enclosure is not removeable with the cartridge inserted.

There is further disclosed an example, wherein the hand enclosure comprises a strap.

There is further disclosed an example, wherein the hand enclosure comprises a knuckle attachment, with knuckle protrusions oriented towards the first end.

There is further disclosed an example, wherein the knuckle attachment is constructed of hardened plastic.

There is further disclosed an example, wherein the knuckle attachment is constructed of brass, aluminum, or steel.

There is further disclosed an example, further comprising a wrist loop.

There is further disclosed an example, further comprising an alarm, wherein the wrist loop is detachable, and wherein detaching the wrist loop activates the alarm.

There is further disclosed an example, wherein the hand enclosure comprises two or more interchangeable attachments.

There is further disclosed an example, wherein the interchangeable attachments include a spiked knuckle attachment and a strap attachment.

There is further disclosed an example, further comprising a key ring to mate with the receiver.

There is further disclosed an example, further comprising a glass breaker to mate with the receiver.

There is further disclosed an example, wherein the main body has a color scheme or pattern selected to appeal to female users.

There is further disclosed an example of a personal safety device, comprising: a main body having an ergonomic grip sized and contoured to fit an average human female hand, and having disposed therein a telescoping friction baton; a light; and a hand enclosure.

There is further disclosed an example, further comprising a shrill siren.

There is further disclosed an example, wherein the main body has a length of between 5 and 7 inches.

There is further disclosed an example, wherein the main body has a length of approximately 6 inches.

There is further disclosed an example, wherein the main body has a diameter between 0.5 and 2.5 inches.

There is further disclosed an example, wherein the main body has a diameter between 1.3 and 1.5 inches.

There is further disclosed an example, wherein the telescoping friction baton has an extended length of approximately 15-16 inches.

There is further disclosed an example, wherein the telescoping friction baton has an extended length of approximately 12 inches.

There is further disclosed an example, wherein the main body has an oblong ergonomic contour.

There is further disclosed an example, further comprising a conducted energy device (CED).

There is further disclosed an example, wherein terminals for the CED are disposed on a tip of the telescoping friction baton.

There is further disclosed an example, further comprising a dual-power supply, including a rechargeable battery and a disposable battery acceptor.

There is further disclosed an example, wherein the CED comprises ejectable electrical leads affixed to wire conductors.

There is further disclosed an example, wherein the CED comprises fixed electrical terminals.

There is further disclosed an example, wherein the telescoping friction baton comprises three telescoping segments.

There is further disclosed an example, wherein the three telescoping segments comprise an outer segment integrated with the main body.

There is further disclosed an example, wherein the three telescoping segments comprise an intermediate segment of a lightweight material.

There is further disclosed an example, wherein the three telescoping segments are constructed of steel, aluminum, carbon fiber, titanium, or a combination thereof.

There is further disclosed an example, wherein the three telescoping segments comprise an outer segment, an intermediate segment, and a core segment, and wherein the core segment is of a hardened material.

There is further disclosed an example, wherein the hand enclosure comprises a strap.

There is further disclosed an example, wherein the hand enclosure comprises a spiked knuckle attachment.

There is further disclosed an example, wherein the spiked knuckle attachment is constructed of hardened plastic.

There is further disclosed an example, wherein the spiked knuckle attachment is constructed of aluminum or steel.

There is further disclosed an example, wherein the hand enclosure comprises two or more interchangeable attachments.

There is further disclosed an example 9, wherein the interchangeable attachments include a spiked knuckle attachment and a strap attachment.

There is further disclosed an example, further comprising a high-intensity light.

There is further disclosed an example, further comprising a key ring on a bottom end of the main body.

There is further disclosed an example, further comprising a glass breaker on a bottom end of the main body.

There is further disclosed an example, wherein the main body has a color scheme or pattern selected to appeal to female users.

### Embodiments of the Disclosure

Personal safety is a pressing concern for individuals throughout the world, and particularly for women and girls. In an ideal or perfect world, there would be no robbery, assault, and or sexual battery. But the reality of life throughout human history and into the 21st century is that there are bad actors willing to harm others. In the particular case of women and girls, it is unfortunately true that the people wishing to harm them are often adult males. In a physical altercation, human females have a statistical physiological disadvantage in relative size and strength compared to adult males. It is therefore desirable for women and girls to carry apparatus that help to mitigate these physiological variances. While it is possible for women to carry lethal weapons such as firearms, this is not always a desirable solution. Personal firearms are heavily regulated or even banned in many countries and even in some regions of the United States. Furthermore, lethal devices such as firearms carry risks that some users may consider unacceptable. For example, an accidental discharge by a curious child who has gained access to an improperly secured firearm can cause serious injury or death.

Thus, there is interest within the population at large, and an enhanced interest with the female population in particular, in securing non-lethal and less lethal self-defense apparatus that women and others can carry. In this specification, a non-lethal apparatus is intended to refer to an apparatus that is not designed to cause death as its primary function. This may exclude, for example, common firearms or other high-speed projectiles, which have a higher likelihood of causing death. Nonlethal apparatus includes devices that may cause pain or discomfort, but that are not intended to cause death as a primary function. Note, however, that non-lethal apparatus may incidentally cause death in relatively rare cases. For example, conducted energy devices (CED) such as tasers, cattle prods, and other electroshock devices are not designed primarily to cause death or permanent disability. Instead, CED's are intended to cause pain or temporary disability, which can allow a victim to escape or the aggressor to be subdued. However, in some cases, a CED that is improperly used or may cause death, or even a properly-used CED may cause death in a person who is unusually susceptible.

Similarly, a lachrymatory agent such as tear gas, pepper spray, or bear spray is not designed primarily to cause death, but may result in death in a person with a severe allergic or anaphylactic reaction to the agent. Thus, these mechanisms are sometimes referred as “less-lethal” devices. In this specification, non-lethal and less-lethal devices may be used synonymously to refer to any self-defense apparatus or weapon that can be used to effectively deter an individual without having a primary purpose or function of causing death or serious or permanent disability.

Embodiments of the present specification include a personal safety device which may provide a plurality of non-lethal self-defense apparatus integrated into a single main body. The main body may be formed with an ergonomic grip that is designed to fit comfortably in the hand of an average human adult female. The grip may have, for example, an overall radius of between 0.5 and 2.5 inches, with one species including a radius between 1.3 and 1.5 inches. One specific embodiment has a diameter of substantially 1.3 inches. The device may have an ergonomic oblong contour so that it fits comfortably within a human hand, which generally does not grip in a perfect circle. Specifically, the device may be sized to fit an average adult human female hand (e.g., at approximately 1.3 inches in diameter), with other embodiments designed to fit an average adult human male hand.

Some embodiments of the device may be finished in colors and/or with patterns that are deliberately targeted to feminine styles and preferences, such as to increase the attractiveness of the device to women and girls. For example, the device may be provided in colors that are considered traditionally feminine in Western culture, such as pink, lavender, or other attractive colors. The device may also be finished with patterns that appeal to feminine sensibilities, such as floral designs, fashion designs, abstract representations of makeup, lipstick, dresses, high-heeled shoes, or other appealing designs. These design choices may specifically increase the attractiveness of the device to female users, who may be considered a primary market segment for some embodiments.

However, the device disclosed herein is not intended to be exclusive to female users. Men and boys can also benefit from the personal safety device disclosed herein, and in those cases the devices may be somewhat larger, such as between 1.0 and 2.0 inches in diameter, and may come in more masculine colors such as darker colors and camouflage patterns. The personal safety device may also be provided in gender-neutral colors that appeal to both men and women, and may be provided in sizes that are intermediate between those targeted for men versus women, such as a diameter of approximately 1.0 inches. Embodiments of the device disclosed herein may also have an overall length of the main body of between 5 and 7 inches, and in one particular embodiment may have an overall length of approximately 6.5 inches.

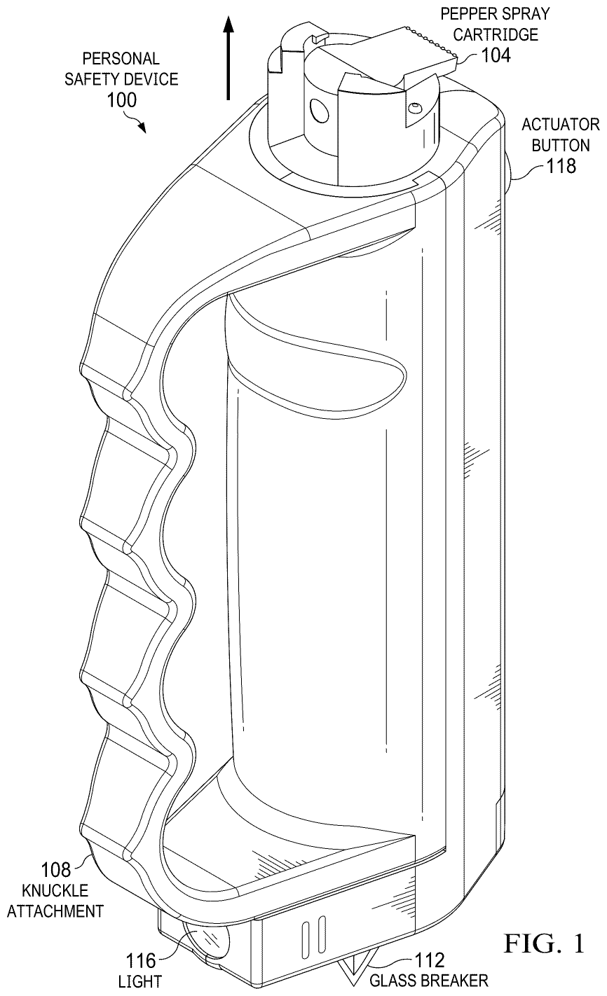

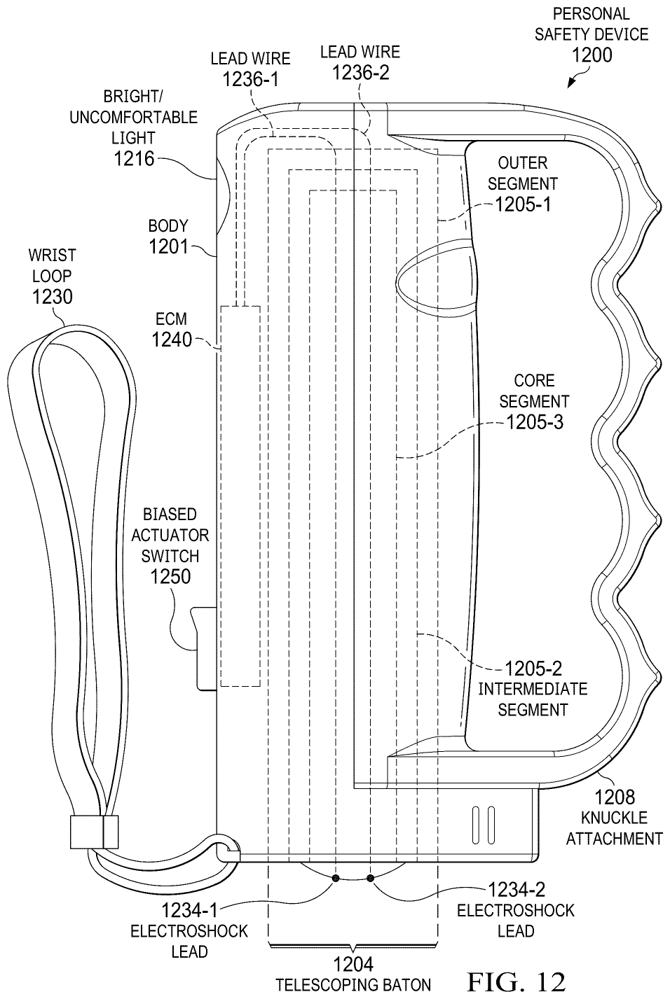

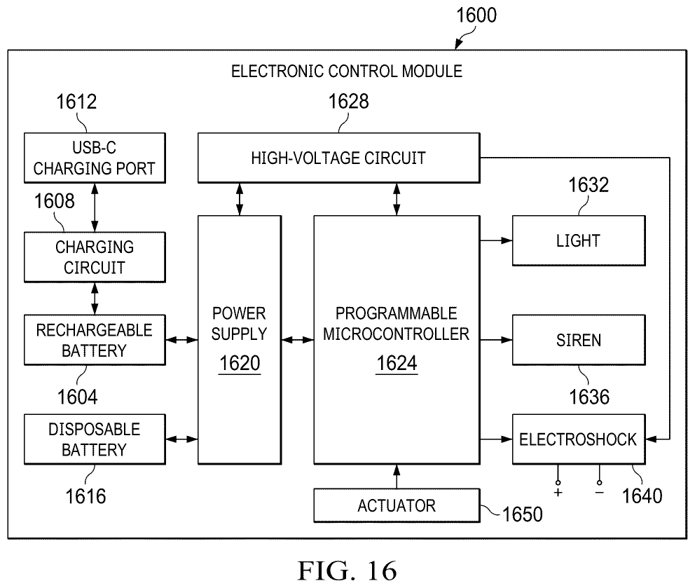

Turning now to the figures, FIG. 1 is a perspective view of a personal safety device 100. Aspects of this embodiment are disclosed in FIGS. 1 through 11, which may represent a single embodiments with optional attachments, or may represent several different embodiments with fixed attachments (e.g., at the bottom). Aspects of another embodiment are illustrated in FIG. 12 through 15. FIG. 16 illustrates an electronic control module (ECM) that may be usable for any of the disclosed embodiments.

In the example of FIG. 1, personal safety device 100 is built around a main body 105. As described above, main body 105 may have a length between 5 and 7 inches. One embodiment has an overall length of 6.1 inches, including bottom attachments and a spray nozzle. Main body 105 may also have a diameter of between 0.5 and 2.5 inches. One embodiment has a diameter of approximately 0.8 inches. Body 105 may have an oblong contour to provide an ergonomic grip.

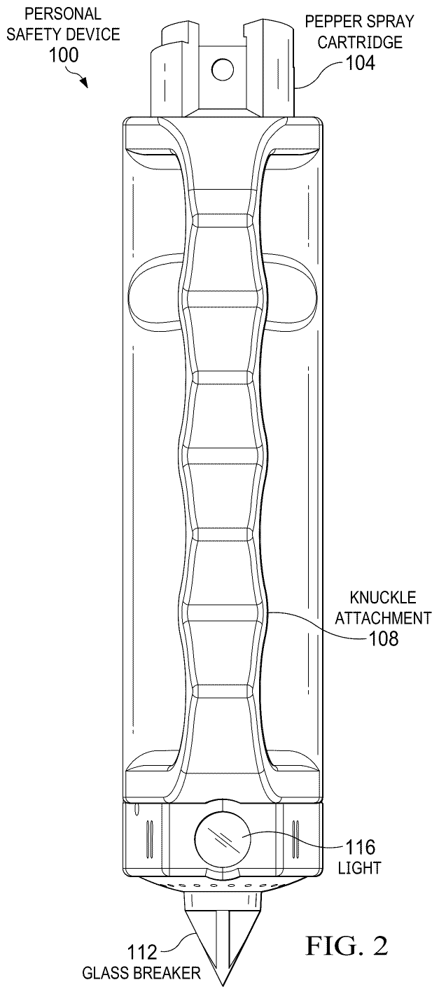

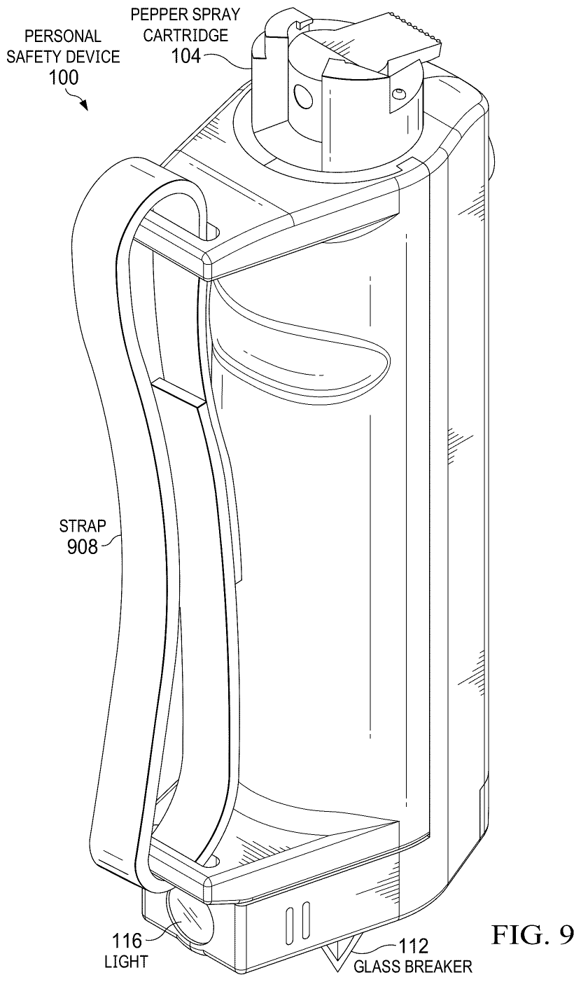

Personal safety device 100 may include a hand enclosure that in this example is a spiked knuckle attachment 108. In this illustration, an open knuckle attachment is illustrated, but other embodiments may be closed and include, for example, discrete finger holes. In some cases knuckle attachment 108 may be replaced with a strap as seen in FIG. 9, strap 908. Further visible in the view of FIG. 1 is a glass breaker 112. The design of glass breaker 112 is more readily apparent in FIG. 2, which is a side view of the same embodiment of personal safety device 100. Glass breaker 112 has a relatively larger diameter base, and tapers to a sharp point. Glass breaker 112 is useful as a defensive weapon, and can also be used to break glass, such as a window, in case of an emergency or entrapment.

Personal safety device 100 may include a light 116. Light 116 may have various features and modes, including various colors and intensities. Light 116 may have various intensities, such as low intensity for providing a small amount of light with minimal compromise of concealment, regular intensity for use as an ordinary flashlight, or high intensity, which may provide a stronger flashlight and can also be used to confuse or disorient an attacker. Light 116 may be an LED or incandescent light. In the case of an LED, light 116 may provide various colors, such as white, red, blue, amber, or other. In one example, light 116 flashes in one or more colors (such as white, or a combination of red and blue) when the alarm is activated. Light 116 may also provide a steady stream or a strobe function, which can provide a single color or can strobe between different colors. Colors and options can be selected with one or more toggle switches, or by cycling through options with a single actuator.

A user may activate light 116 by pressing actuator button 118. Actuator button 118 may be a single button that can be used to cycle through several functions of light 116. Alternatively, actuator button may include or have associated therewith, one or more toggles, selector switches, or selection means to select a function for light 116. Embodiments of actuator button 118 may also have a built in backlight, which may serve as a battery life indicator, and may flash in different colors depending on the battery life (e.g., blue for very high charge, green for high charge, yellow for medium charge, orange for low charge, and red for very low charge, or other color combinations). Activation of the indicator light may occur when the button is pressed, and may continue for a short time, such as one second.

Pressing actuator button 118 for a time, such as two or three seconds, may also turn off the alarm if activated.

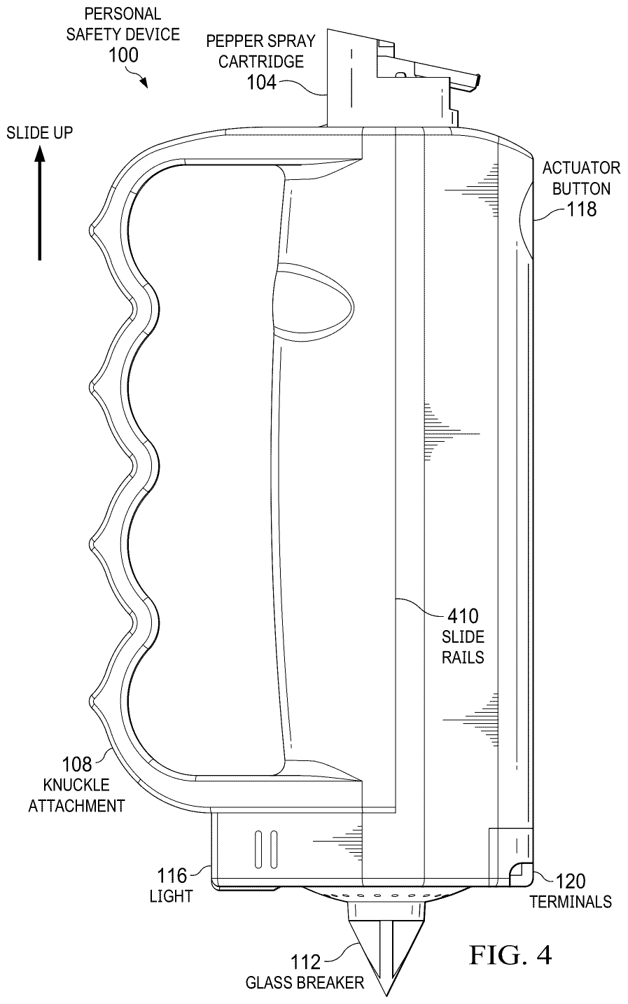

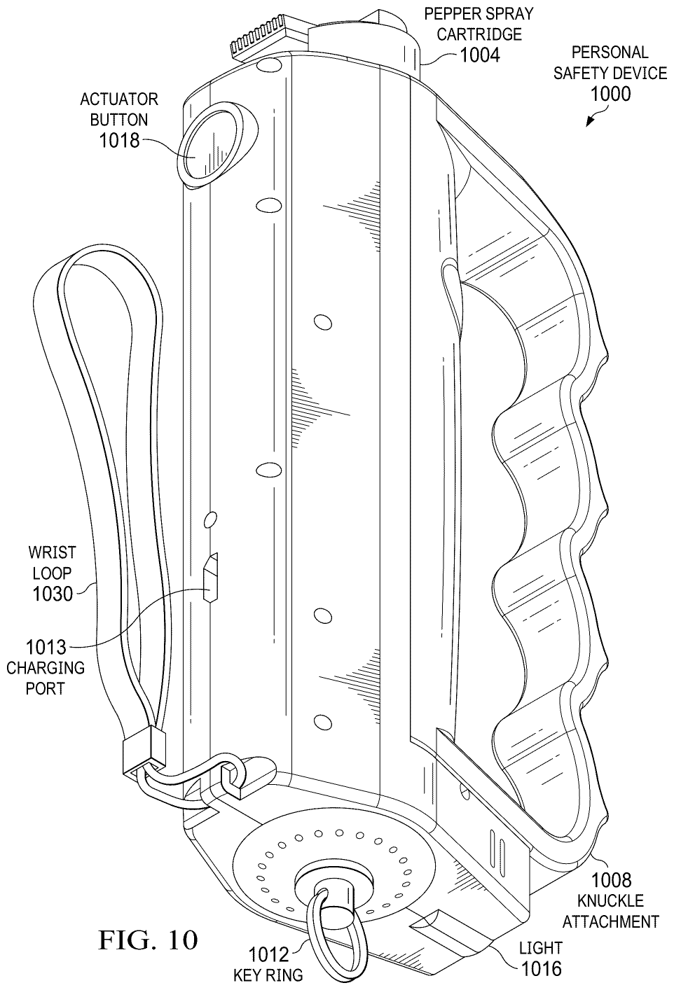

As seen in FIG. 4, electrical terminals 120 are located near the bottom of body 105. Terminals 120 may interact with an actuator mechanism, such as a wrist loop 1030 (FIG. 10). Wrist loop 1030 may be attached to a pull pin. When wrist loop 1030 is pulled off main body 105 with a sharp motion, the removal of the pull pin may activate an alarm. An internal speaker, which may make a loud or shrill sound, may activate. Speaker ports 122 (FIG. 7) may help to make the sound more perceptible. The alarm may be loud and uncomfortable enough to deter attackers, and may also help to alert passers-by that an incident is occurring.

Terminals 120 may also provide different functions in different embodiments. For example, in an alternative embodiment terminals 120 provide electroshock terminals for a CED, which can be used to stun an attacker and provide time to flee. Such electroshock terminals may be fixed to body 105, or they may be spring-loaded and ejectable so that they can contact an attacker at distance.

In yet another embodiment, terminals 120 may be replaced with additional lights or other functions.

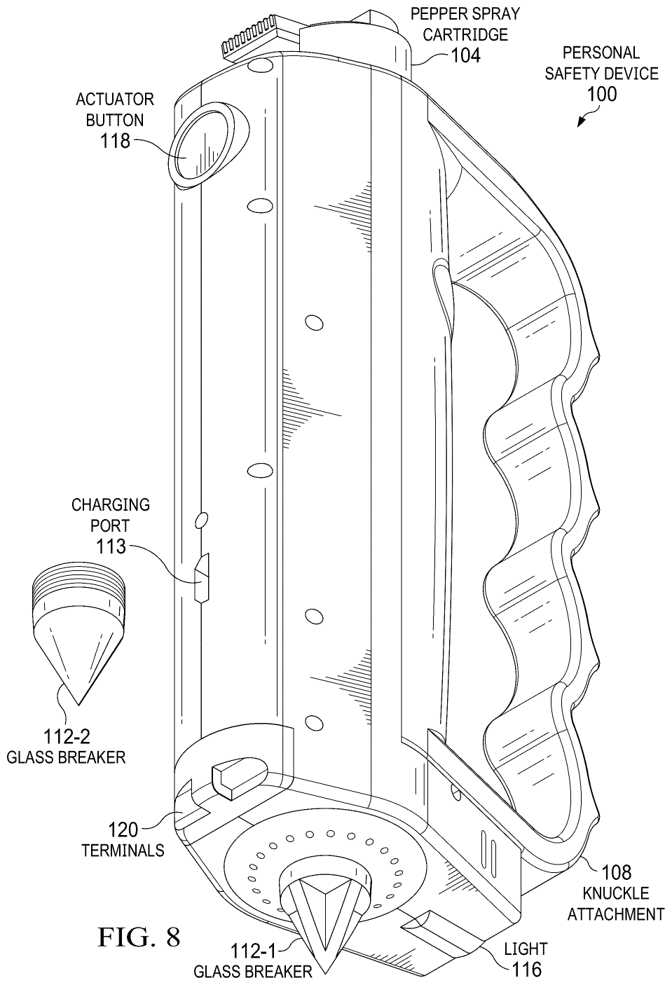

Further visible in FIG. 2 is a glass breaker 112. Glass breaker 112 may provide an optional attachment, which may screw into a threaded receiver on the bottom of personal safety device 100. Other optional attachments may include a key ring 1012 (FIG. 10), or an alternative-style glass breaker 112-2 (FIG. 8). Various attachments may be provided as options and/or upgrades. For example, a base model may include key ring 1012, while an upgrade may include glass breaker 112-1 (FIG. 8) or glass breaker 112-2 (FIG. 8). Other options may include electroshock terminals (with an appropriate supporting ECM 1600 (FIG. 16), Bluetooth transceiver, GPS tracker, pedometer, stop watch, clock, dog leash connector, water bottle holder, dispenser for feces bags for dogs, or a pepper ball shooter.

Personal safety device 100 may have illustrative dimensions of 6.1 inches high (including glass breaker 112), 2.8 inches wide (including knuckle attachment 108), and 1.3 inches thick, with a weight of approximately 4 ounces.

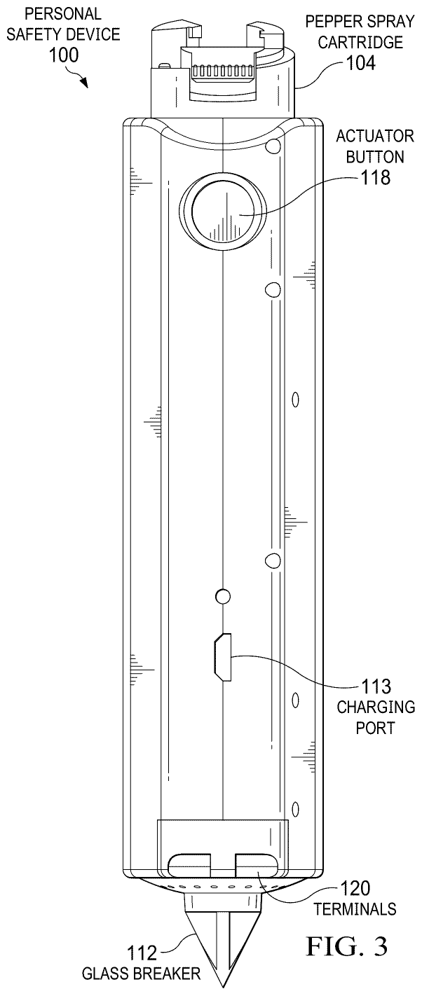

FIG. 3 is a rear view of personal safety device 100, in which various of the features previously described are visible, including terminals 120, light 116, and glass breaker 112. Also visible in this view is a charging port 113, which may be used to charge a battery of personal safety device 100. Charging port 180 may be a USB port, such as USB-C, micro-USB, USB-mini, or other charging interface.

As an additional deterrent, personal safety device 100 may include a lachrymatory agent such as an aerosol pepper spray, or other irritant such as tear gas, capsaicin spray, bear spray, or any mixture thereof. Embodiments may also provide a non-irritant practice spray, such as water or some other innocuous liquid.

As illustrated in FIG. 4, any of the embodiments of a personal safety device disclosed herein may include an interchangeable hand enclosure. The hand enclosure is shown in the example of FIG. 4 as a hard knuckle attachment with spiked tips. Hard knuckle attachment 108 may be constructed of, for example, hard plastic, metal (such as steel, aluminum, or brass), carbon fiber, or other strong material. In this case, knuckle attachment 108 may engage main body 105 with slide rails 410. Knuckle attachment 108 slides upward on slide rails 410 to detach from main body 105. Knuckle attachment 108 may be secured to slide rails 410 via locking tabs or pins, which in some embodiments may be engaged by cartridge 104, so that knuckle attachment 108 cannot be removed while cartridge 104 is inserted.

Pepper spray cartridge 104 may be a disposable or rechargeable cartridge. Pepper spray cartridge 104 may include pepper spray, pepper gel tear gas, bear spray, or other irritants. Additional embodiments may include a pepper ball “shooter” that dispenses irritant pepper balls with modest, non-lethal force. Practice spray may also be included, with inert spray such as clean water, to practice spraying without harm.

Cartridge 104 may lock or snap into place, and when it is in place it may secure knuckle attachment 108 so that it does not accidentally slide off of main body 105. For example, an orifice within main body 105, or circumscribed by main body 105 and hand enclosure 108 may have a diameter slightly smaller than the normal diameter of cartridge 104. When cartridge 104 engages the orifice and locks into place, the orifice slightly expands, forcing hand enclosure 108 and main body 105 slightly away from each other, thus strengthening their connection. Cartridge 104 may also engage a mechanical locking or blocking mechanisms that prevent hand enclosure 108 from sliding up on slide rails 410 when cartridge 104 is inserted. To remove hand enclosure 108, cartridge 104 is first removed from its enclosure, which relieves the tension between hand enclosure 108 and main body 105. This may also effectively disengage any obstruction or locking mechanisms. Hand enclosure 108 is then free to slide up and out of slide rails 410. This can be used to replace enclosure 108 with a hand enclosure of a different material, different style, a different color, a newer hand enclosure, or a different type of hand enclosure. For example, FIG. 9 illustrates an embodiment wherein the hand enclosure is a strap 908. Strap 908 may be more comfortable to carry, but may be a compromise in that it does not provide substantial defensive capabilities.

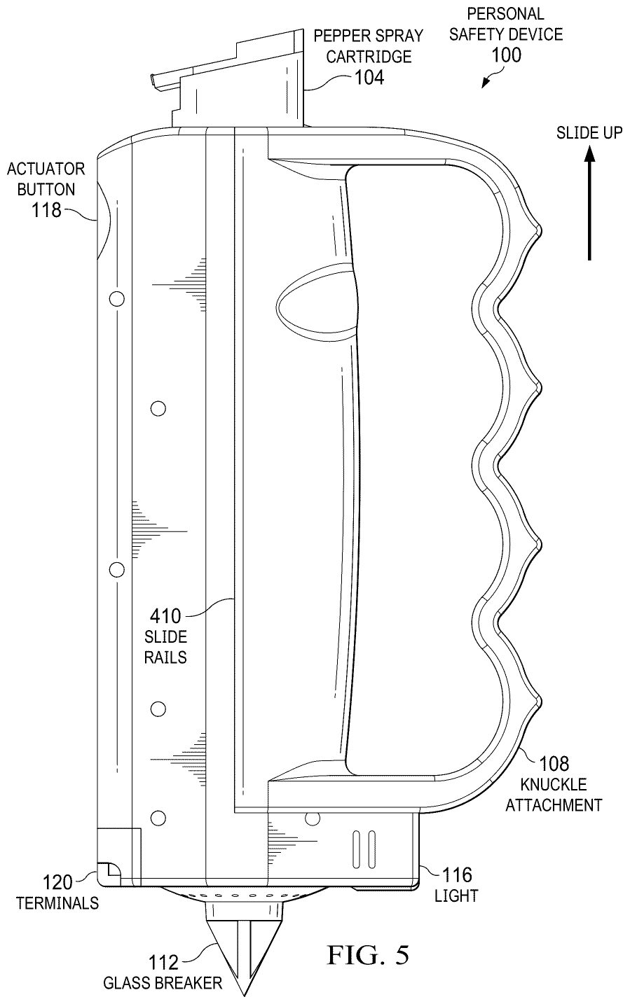

FIG. 5 is an additional side view of the same embodiment of personal safety device 100, again illustrating several aspects such as spray cartridge 104, knuckle grip 108, light 116, terminals 120, and glass breaker 112.

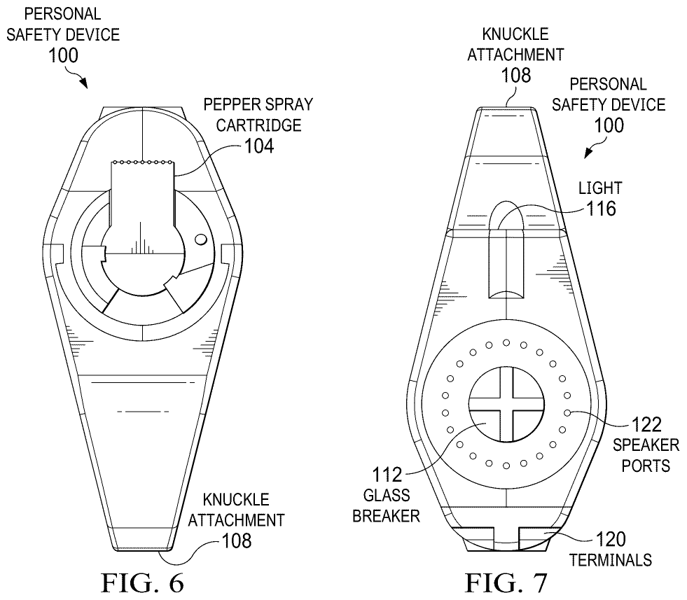

FIG. 6 is a top view of personal safety device 100, in which spray cartridge 104 and knuckle grip 108 are visible. In FIG. 6, it is evident that pepper spray cartridge 104 is oriented with its nozzle toward hand enclosure 108. This is beneficial because, in a self-defense context, the defendant may need to fend off an attacker with multiple apparatus. The defendant can, if necessary, punch the attacker with knuckle attachment 108, and can also use pepper spray cartridge 104 to shoot a stream or aerosol of irritant spray towards the attacker. This combination of defensive techniques may have a synergistic effect. For example, if the attacker comes at the defendant, and the defendant strikes the attacker with spiked knuckle attachment 108, this may break skin. Irritant spray 104 may be especially uncomfortable on broken skin.

FIG. 7 is a bottom view of personal safety device 100, in which glass breaker 112, terminals 120, and knuckle grip 108 are visible. Glass breaker 112 may similarly provide a synergistic effect with irritant spray 104 by breaking skin or causing minor injury.

FIG. 8 is a bottom perspective view of the same embodiment of personal safety device 100, in which spray cartridge 104, light 116, terminals 120, knuckle grip 108, and glass breaker 112 are visible.

Also visible in this view is charging port 113, which may be used to charge a reusable or chargeable battery, such as a Lithium-Ion or other rechargeable battery.

A threaded receiver in personal safety device (here shown holding glass breaker 112-1) may be configured to receive various optional attachments, such as alternative glass breaker 112-2, a key ring 1012 (FIG. 10), an electroshock device, or other.

FIG. 9 is a perspective view of personal safety device 100. In this example, knuckle attachment 108 has been replaced with a strap attachment 908. Strap 908 is another example of a hand enclosure, and can be affixed in the manner previously described. Cartridge 104 may be removed, thus relieving tension between the two pieces, knuckle attachment 108 can be slid away from body 105 on slide rails, and then strap 908 can be slid onto the slide rails of body 105. Finally, spray cartridge 104 can be placed back in its slot, thus providing tension between strap 908 and body 105.

An illustrative example of this embodiment has a height of 6.1 inches (including glass breaker 112-1 and pepper spray cartridge 104), a width of 2.5 inches (including strap 908), and a thickness of 1.3 inches, with a weight of approximately 4 ounces.

FIG. 10 illustrates an alternative to glass breaker 112. In some examples, glass breaker 112 may be a bottom attachment that is not permanently affixed to body 105. Rather, glass breaker 112 may be screwed into a receiver slot on the bottom of body 105. In that case, glass breaker 112 can be replaceable with other attachments. For example, glass breaker 112 may be made of hardened plastic, metal, such as steel, aluminum, brass, or other, or carbon fiber. Different options may be provided as interchangeable pieces or accessories. In another embodiment, personal safety device 1000 (which may be the same or a different embodiment) includes a key ring 1012 in lieu of glass breaker 112.

In some examples, personal safety device 1000 may be otherwise substantially identical to personal safety device 100. This may include the provision of a pepper spray cartridge 1004, knuckle attachment 1008, a charging port 1013, a light 1016, actuator button 1018, terminals (in this view, covered by wrist loop 1030), and other similar examples. In this case, a wrist loop 1030 is also provided, which may be beneficial for carrying in cases where knuckle attachment 1008 is used instead of a strap. Wrist loop 1030 can also be used to actuate an alarm mode, as described above, such as by sharply pulling away wrist loop 1030.

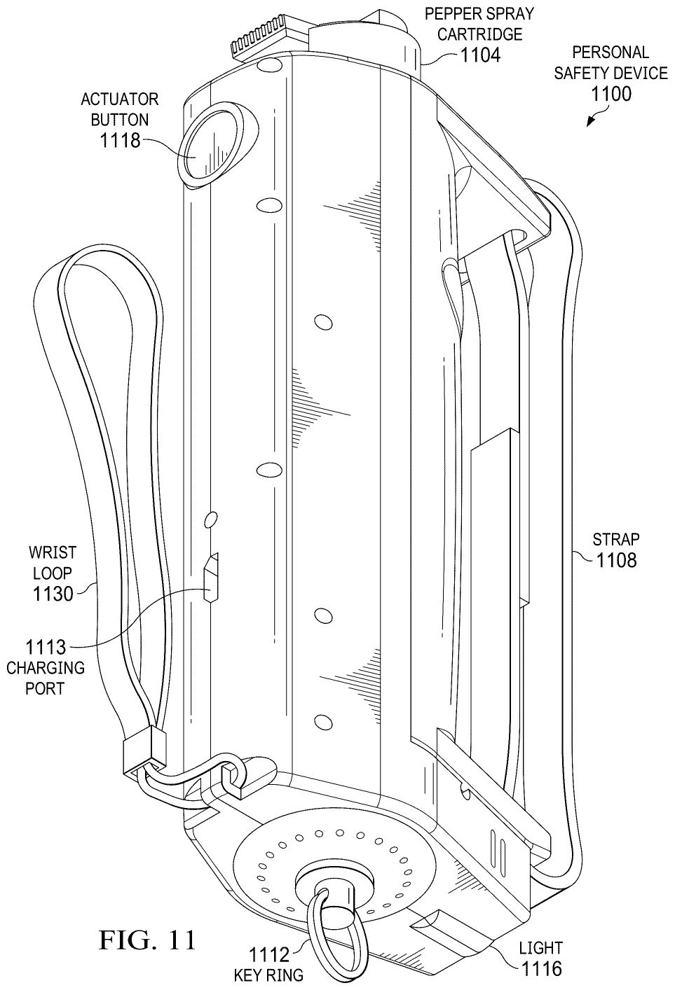

FIG. 11 illustrates another embodiment of a personal safety device 1100. In this example, a pepper spray cartridge 1104 is provided, along with a light 1116, terminals (in this view, covered by wrist loop 1130), a wrist loop 1130, and a strap 1108, a charging port 1113, and actuator button 1118. A key ring 1112 is also provided similar to key ring 1012 of FIG. 10. In this case, knuckle attachment 1008 has been replaced with strap 1108. Notably, embodiments of personal safety device 100, 1000, and 1100 may be different embodiments with different permanent features, or may be a single embodiment wherein replaceable accessories have been switched out.

FIGS. 12, 13, 14, and 15 illustrate an alternative embodiment of a personal safety device. As before, these may be the same embodiment with different accessories, or may be separate embodiments with permanent fixtures.

FIG. 12 illustrates personal safety device 1200. Personal safety device 1200 is, in many respects, similar to personal safety device 100 of FIG. 1. Personal safety device 1200 includes a main body 1201, a knuckle attachment 1208, a wrist loop 1230, and a light 1216, and terminals 1220, which may provide an alarm and flashing lights or CED as appropriate.

Personal safety device 1200 is different from device 100 and other devices in that instead of a pepper spray cartridge, device 1200 includes a telescoping friction baton 1204. Telescoping friction baton 1204 may have an appropriate size and shape, and in this embodiment is illustrated as a three-segment telescoping baton. Baton 1204 may be extended manually, or with a sharp flick of the wrist. Baton 1204 may then be retracted by manually pushing, or with a firm tap on the ground.

Telescoping baton 1204 includes an outer segment 1205-1, and intermediate segment 1205-2, and a core segment 1205-3. In this example, outer segment 1205-1 is integrated with the main body 1201 of personal safety device 1200. When extended, friction baton 1204 can be used to ward off an attacker.

In this example, telescoping friction baton 1204 also includes on a butt on core segment 1205-3, with a pair of electroshock leads 1230 far-one and 1234-2. These may be leads for a CED, and can be used to deliver a shock to an attacker. Leads 1234 may be affixed to the bottom of the baton, or they may be spring loaded and ejectable to disable an attacker at distance. Lead wires 1236-1 and 1236-2 may have some slack in them to allow for extension and/or ejection, and may connect to an ECM, which provides electronic control. The electroshock feature may be actuated with a biased actuator switch 1250. Biased actuator switch 1250 may be biased toward an off position. Thus, leads 1234-1 and 1234-2 are activated only when the switch is pressed. This delivers electroshock, and the electroshock ceases when the switch is released and returns to its bias off position.

In one embodiment, electroshock leads 1234 may be spring loaded on the butt of core segment 1205-3 to help mitigate damage to the leads if the butt is tapped on a hard surface to retract friction baton 1204.

An ECM 1240 may provide electronic control in this or in other embodiments. Selected elements of an ECM are illustrated in FIG. 16 below.

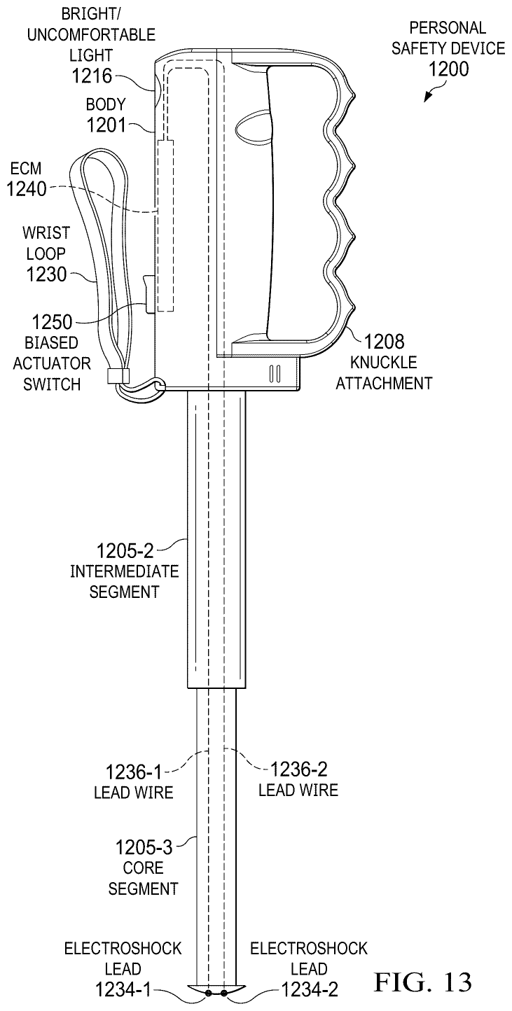

FIG. 13 is an example of personal safety device 1200, illustrating telescoping baton 1204 in an extended position. In this case, it can be seen that outer segment 1205-1 is integrated with the main body 1201. Intermediate segment 1205-2 telescopes out from outer segment 1205-1. Core segment 1205-3 telescopes out from intermediate segment 1205-2.

Telescoping friction baton 1204 may have retracted length of, for example, 6 to 6.5 inches, and an extended length of approximately 15-16 inches. Other embodiments may have a shorter baton that is easier for a person of smaller stature to use, such as approximately 12 inches extended. The baton segments may be made of a strong material such as steel (e.g., 4140 steel or other), aluminum (including aircraft aluminum), titanium, carbon fiber, or other.

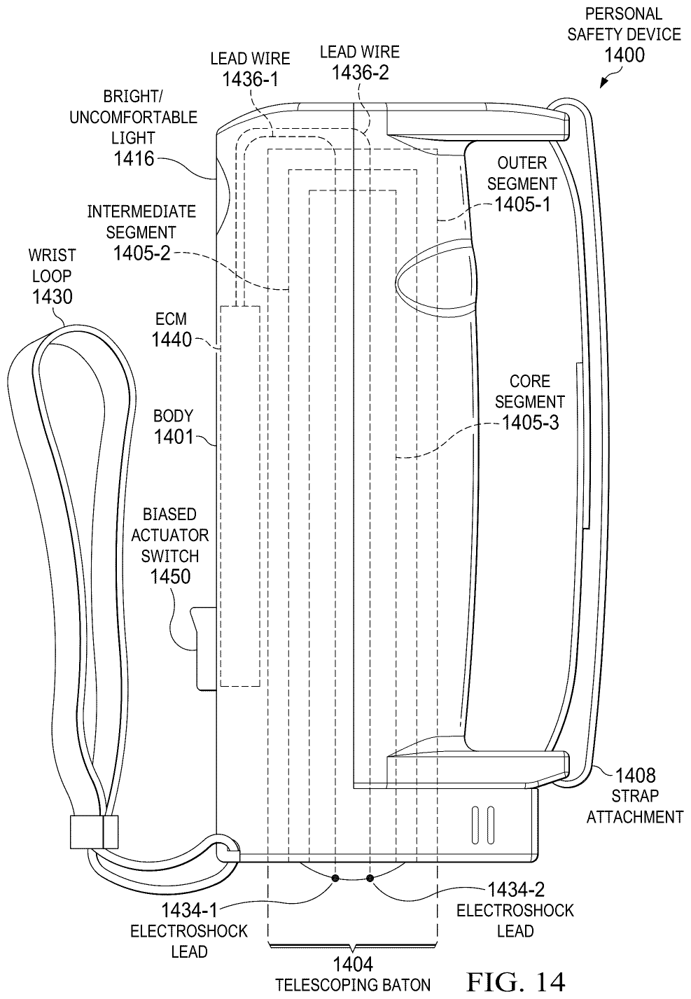

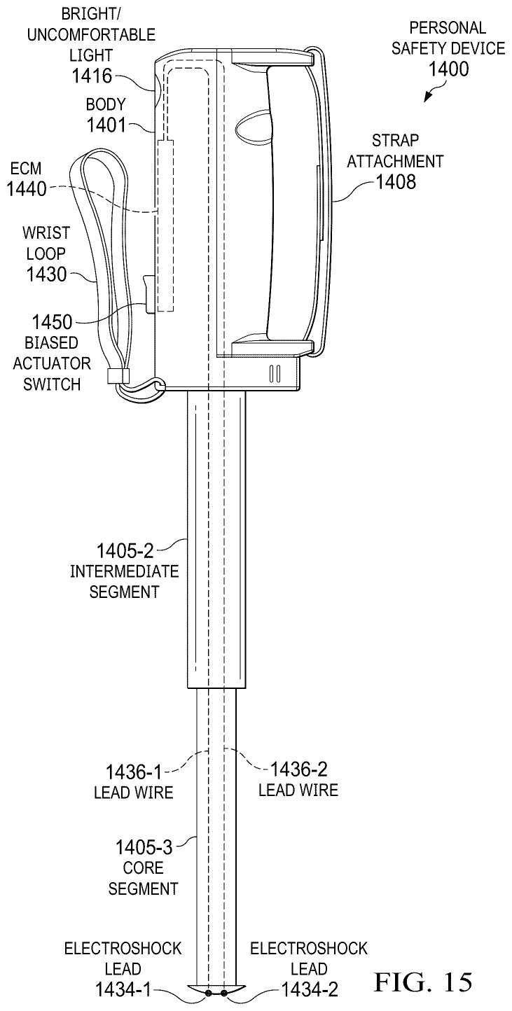

FIGS. 14 and 15 illustrate an embodiment of a personal safety device that is similar in many respects to personal safety device 1200 of FIGS. 12 and 13. Personal safety device 1400 may be an example of personal safety device 1200 with optional accessories. In this case, personal safety device 1400 includes a body 1401, a telescoping baton 1404, outer segment 1405-1, intermediate segment 1405-2, core segment 1405-3, light 1416, terminals 1420, wrist loop 1430, electroshock leads 1434-1, 1434-2, lead wires 1436-1, 1436-2, ECM 1440, and biased actuator switch 1450. In this illustration, knuckle attachment 1208 has been replaced with a wrist loop 1430. Both strap attachment 1408 and knuckle attachment 1208 may be embodiments of hand enclosures, and as in other embodiments, these may be interchangeable so that both embodiments may be the same embodiment. Because there is no spray cartridge to provide expansion, the attachment may lock into place with a latch or other secure mechanism.

Embodiments of straps 108, 908, 1108, 1408 and/or wrist loop 1030, 1130, 1230, 1430 may be constructed of materials such as leather, nylon, spandex, or others. Some embodiments of straps 108, 908, 1108, 1408 may have discrete finger holes instead of being open, providing a more secure grip. Embodiments of straps 108, 908, 1108, 1408 may also include attachments such spikes or brass knuckles. Other embodiments may include holders or dispensers, such as a water bottle holder, trash bags (e.g., for dispensing feces bags while walking a dog), a dog leash or dog leash connector, or an attached small CED.

FIG. 16 is a block diagram of an electronic control module (ECM) 1600. ECM 1600 may provide any of the electronic control functions illustrated throughout this specification, and may be provided in any of the embodiments disclosed herein (e.g., personal safety devices 100, 1000, 1100, 1200, and/or 1400).

In this example, ECM 1600 may provide alternative or dual battery configuration. For example, a disposable battery receiver 1616 may receive disposable batteries such as AA or AAA batteries. Instead of or in addition to disposable batteries, a rechargeable battery 1604 may also be provided. A charging circuit 1608 may control charge to rechargeable battery 1604, and a charging port 1612 such as a USB-C, USB micro, or USB mini, may be provided to physically interface with the charging mechanism.

A power supply 1620 receives power from one or both of disposable battery 1616 and rechargeable battery 1604. For example, disposable battery 1616 may be a backup to rechargeable battery 1604 so that the device has a backup and does not run out of power at an inopportune moment such as during an attack.

A high voltage circuit 1628 may receive energy from power supply 1620, and may deliver high voltage at low current to electroshock circuit 1640. Electroshock circuit 1640 may power a CED as illustrated herein.

Actuator 1650 may represent any of the actuators illustrated herein, such as actuator buttons 118, 1018, 1118, 1250, 1450, pull pins for alarms, or other various buttons, switches, toggles, and controls.

A programmable microcontroller 1624 may receive signals from one or more actuators 1650. This may include one or more on/off switches, as well as toggles to select between various options such as colors, intensity, or functions.

Programmable microcontroller 1624 may control outputs such as one or more lights 1632 and one or more sirens 1636.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

The particular embodiments of the present disclosure may readily include a system on chip (SOC) central processing unit (CPU) package. An SOC represents an integrated circuit (IC) that integrates components of a computer or other electronic system into a single chip. It may contain digital, analog, mixed-signal, and radio frequency functions: all of which may be provided on a single chip substrate. Other embodiments may include a multi-chip-module (MCM), with a plurality of chips located within a single electronic package and configured to interact closely with each other through the electronic package. In various other embodiments, the digital signal processing functionalities may be implemented in one or more silicon cores in Application Specific Integrated Circuits (ASICs), Field Programmable Gate Arrays (FPGAs), and other semiconductor chips.

Additionally, some of the components associated with described microprocessors may be removed, or otherwise consolidated. In a general sense, the arrangements depicted in the figures may be more logical in their representations, whereas a physical architecture may include various permutations, combinations, and/or hybrids of these elements. It is imperative to note that countless possible design configurations can be used to achieve the operational objectives outlined herein. Accordingly, the associated infrastructure has a myriad of substitute arrangements, design choices, device possibilities, hardware configurations, software implementations, equipment options, etc.

Any suitably-configured processor component can execute any type of instructions associated with the data to achieve the operations detailed herein. Any processor disclosed herein could transform an element or an article (for example, data) from one state or thing to another state or thing. In another example, some activities outlined herein may be implemented with fixed logic or programmable logic (for example, software and/or computer instructions executed by a processor) and the elements identified herein could be some type of a programmable processor, programmable digital logic (for example, a field programmable gate array (FPGA), an erasable programmable read only memory (EPROM), an electrically erasable programmable read only memory (EEPROM)), an ASIC that includes digital logic, software, code, electronic instructions, flash memory, optical disks, CD-ROMs, DVD ROMs, magnetic or optical cards, other types of machine-readable mediums suitable for storing electronic instructions, or any suitable combination thereof. In operation, processors may store information in any suitable type of non-transitory storage medium (for example, random access memory (RAM), read only memory (ROM), field programmable gate array (FPGA), erasable programmable read only memory (EPROM), electrically erasable programmable ROM (EEPROM), etc.), software, hardware, or in any other suitable component, device, element, or object where appropriate and based on particular needs. Further, the information being tracked, sent, received, or stored in a processor could be provided in any database, register, table, cache, queue, control list, or storage structure, based on particular needs and implementations, all of which could be referenced in any suitable timeframe. Any of the memory items discussed herein should be construed as being encompassed within the broad term ‘memory.’

Computer program logic implementing all or part of the functionality described herein is embodied in various forms, including, but in no way limited to, a source code form, a computer executable form, and various intermediate forms (for example, forms generated by an assembler, compiler, linker, or locator). In an example, source code includes a series of computer program instructions implemented in various programming languages, such as an object code, an assembly language, or a high-level language such as OpenCL, Fortran, C, C++, JAVA, or HTML for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

In one example embodiment, any number of electrical circuits of the FIGURES may be implemented on a board of an associated electronic device. The board can be a general circuit board that can hold various components of the internal electronic system of the electronic device and, further, provide connectors for other peripherals. More specifically, the board can provide the electrical connections by which the other components of the system can communicate electrically. Any suitable processors (inclusive of digital signal processors, microprocessors, supporting chipsets, etc.), memory elements, etc. can be suitably coupled to the board based on particular configuration needs, processing demands, computer designs, etc. Other components such as external storage, additional sensors, controllers for audio/video display, and peripheral devices may be attached to the board as plug-in cards, via cables, or integrated into the board itself. In another example embodiment, the electrical circuits of the FIGURES may be implemented as stand-alone modules (e.g., a device with associated components and circuitry configured to perform a specific application or function) or implemented as plug-in modules into application specific hardware of electronic devices.

Note that with the numerous examples provided herein, interaction may be described in terms of two, three, four, or more electrical components. However, this has been done for purposes of clarity and example only. It should be appreciated that the system can be consolidated in any suitable manner. Along similar design alternatives, any of the illustrated components, modules, and elements of the FIGURES may be combined in various possible configurations, all of which are clearly within the broad scope of this Specification. In certain cases, it may be easier to describe one or more of the functionalities of a given set of flows by only referencing a limited number of electrical elements. It should be appreciated that the electrical circuits of the FIGURES and its teachings are readily scalable and can accommodate a large number of components, as well as more complicated/sophisticated arrangements and configurations. Accordingly, the examples provided should not limit the scope or inhibit the broad teachings of the electrical circuits as potentially applied to a myriad of other architectures.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “steps for” are specifically used in the particular claims; and (b) does not intend, by any statement in the specification, to limit this disclosure in any way that is not otherwise reflected in the appended claims.

1-84. (canceled)

85. A personal safety device, comprising:
a main body having disposed therein a non-lethal defensive weapon;
a hand enclosure;
a light; and
a bottom attachment;
wherein the main body is constructed with a size and shape to comfortably fit an average human female hand.

86. The personal safety device of claim 85, wherein the main body has a length of approximately 6 inches.

87. The personal safety device of claim 85, wherein the main body has a diameter between 1.3 and 1.5 inches.

88. The personal safety device of claim 85, wherein the main body has an oblong ergonomic contour.

89. The personal safety device of claim 85, wherein the non-lethal defensive weapon comprises an aerosol lachrymatory agent.

90. The personal safety device of claim 85, wherein the non-lethal defensive weapon comprises a telescoping friction baton with a conducted energy device (CED).

91. The personal safety device of claim 85, wherein the hand enclosure comprises a strap.

92. The personal safety device of claim 85, wherein the hand enclosure comprises a knuckle weapon or wrist strap.

93. The personal safety device of claim 85, further comprising an alarm and a wrist loop, wherein the wrist loop is detachable, and wherein detaching the wrist loop activates the alarm.

94. The personal safety device of claim 85, wherein the bottom attachment comprises a key ring or glass breaker.

95. The personal safety device claim 85, wherein the main body has a color scheme or pattern selected to appeal to female users.

96. A personal safety device, comprising:
a main body having disposed therein an aerosol lachrymatory agent cartridge, with a spray nozzle oriented towards a first end of a short axis of the personal safety device;
a hand enclosure located on the first end;
a receiver for an attachment, the receiver located on a bottom end of a long axis of the personal safety device;
a light oriented towards the first end; and
an actuator button on a second end of the short axis of the personal safety device;
wherein the main body is constructed with a size and shape to comfortably fit an average human female hand.

97. The personal safety device of claim 96, wherein the main body has a length of approximately 6 inches.

98. The personal safety device of claim 96, wherein the cartridge interlocks with the hand enclosure, whereby the cartridge is not removeable with the hand enclosure attached.

99. The personal safety device of claim 96, wherein the hand enclosure comprises two or more interchangeable attachments.

100. The personal safety device of claim 96, wherein the hand enclosure comprises a knuckle attachment or a strap attachment.

101. The personal safety device of claim 96, further comprising a key ring to mate with the receiver.

102. The personal safety device of claim 96, further comprising a glass breaker to mate with the receiver.

103. A personal safety device, comprising:
a main body having an ergonomic grip sized and contoured to fit an average human female hand, and having disposed therein a telescoping friction baton;
a light; and
a hand enclosure.

104. The personal safety device of claim 103, wherein the main body has a length of approximately 6 inches, and the telescoping friction baton has an extended length of between 12 and 16 inches.
